(19) United States
(12) Patent Application Publication
(10) Pub. No.: US 2011/0060730 A1
(43) Pub. Date: Mar. 10, 2011

(54) REVERSE PORTAL SYSTEM AND METHOD

(76) Inventor: Rejean Desrosiers, Mississauga (CA)

(21) Appl. No.: 12/991,684

(22) PCT Filed: May 6, 2009
(86) PCT No.: PCT/IB09/05512

§ 371 Date: Nov. 8, 2010

Related U.S. Application Data
(60) Provisional application No. 61/071,575, filed on May 6, 2008.

(51) Int. Cl. G06F 17/30

(52) U.S. Cl. 707/708; 707/E17.108

(57) ABSTRACT

The reverse portal system and method (100) includes a search engine for finding products specified by consumers. Only registered users may search and communicate through the website. Privacy of registered users' searches is maintained. Only consumers may directly contact businesses associated with the products. Solicitation from the businesses is in response to the consumer's search, and may only be directed to a nickname established by the consumer for anonymity. The method accepts only consumers who register with the system (100) and obtain an anonymous username. Businesses are offered “organic listings” or pay per click preferred listings.

### TECHNICAL FIELD

The present invention relates to Internet websites, and more specifically to an organized and qualified Internet reverse portal system and method that allows for the consumer to submit a request for a product or a service and receive responses from various providers for such product or service. The method in which the consumer finds the product or service is provided by a search engine specific to the reverse portal and enhancing the methodology used from start to finish.

### BACKGROUND ART

When people want to research specific information or find products and services, they often conduct searches on Internet search engines so that they can see results delivered to their monitor very quickly. The results are often in the millions, and people may only take the time to look at the paid links (pay per click), and to look in the “organic result pages” from businesses that have, through search engine optimization (SEO), been able to successfully be listed in the first page results.

The downside of delivering millions of “organic results” and “paid results” is people rarely visit more than three pages because it is time consuming. Most of the time, people get frustrated, as they don't find what they are really looking for. In addition, people see many results unrelated to their search, since the search engines function on key word(s) and pay per clicks.

Moreover, business merchants have problems using traditional search engines because they list their website on the search engines in the hope that, with Search Engine Optimization (SEO), their website will eventually be listed in the top ten organic results on these search engines.

To ensure that they are listed at the very top of the page results (or under the sponsored links on the right side of the page results), some businesses purchase “pay per clicks” on diverse search engines. In order to reach as many potential customers as possible, businesses must spend substantial amounts of money on “pay per clicks,” as there are thousand of search engines and directories on the Internet.

Also, since search engines return millions of pages, people rarely go beyond the third page so that most businesses spend substantial sums of money on their website and never see a return on their money because people cannot find them. Additionally, according to traditional search engine methodologies, the search engine operators only make money by selling “Pay Per Click” advertisements. They do not earn money when people click on “Organic Results.”

Thus, a reverse portal system and method solving the aforementioned problems is desired.

### DISCLOSURE OF INVENTION

The reverse portal system and method registers a profile of at least one consumer in order to conduct a search using a merchant search website. A user is compelled to provide an anonymous nickname for use in conducting searches and communicating with merchants who have registered with the website. A plurality of products and services offered by the merchants is accepted into a searchable database.

The system receives consumer inquiries regarding products or services specified by the consumer. The system then searches the database for information regarding the products or services specified by the consumer.

Responsive to results from the database search, a communication to merchants who potentially may carry the product or offer the service is sent, the communication inviting a solicitation regarding the consumer's product or service inquiry. If the merchant chooses to respond with a solicitation, the system receives the offer from the merchant to pay for the solicitation, the solicitation being associated with the product or service specified by the consumer.

The system then debits an account of the merchant, the debiting of the account being an acceptance of the solicitation offer from the merchant. Subsequently, the system communicates the merchant's solicitation to the anonymous nickname belonging to the registered consumer who initiated the search, thus maintaining privacy of the search results and consumer identity.

These and other features of the present invention will become readily apparent upon further review of the following specification and drawings.

### BRIEF DESCRIPTION OF THE DRAWINGS

FIG. 1 is a block diagram of an exemplary network configuration for a reverse portal system and method according to the present invention.

FIG. 2 is a flowchart listing the steps in a reverse portal method according to the present invention.

FIG. 3 is an exemplary screenshot of a login page for a reverse portal system according to the present invention.

FIG. 4 is an exemplary screenshot of a search page for a reverse portal system according to the present invention.

FIG. 5 is an exemplary screenshot of a search results page for a reverse portal system according to the present invention.

FIG. 6 is a sitemap diagram showing page navigation of a website in a reverse portal method according to the present invention.

Similar reference characters denote corresponding features consistently throughout the attached drawings.

### BEST MODES FOR CARRYING OUT THE INVENTION

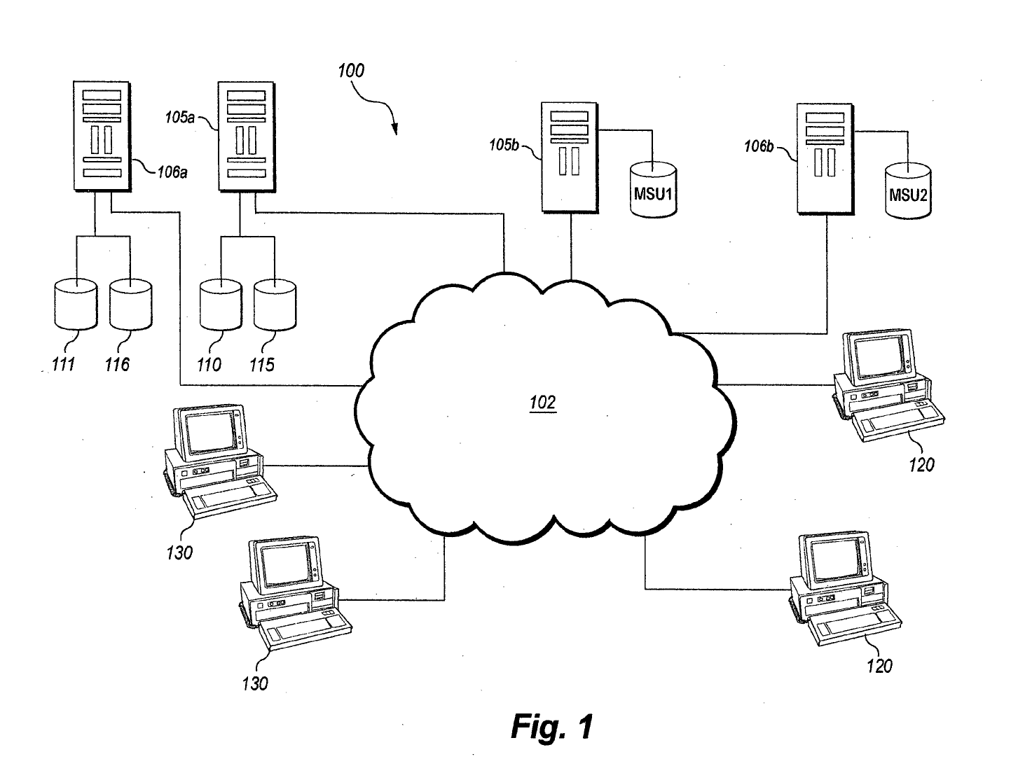

The present invention relates to a reverse portal system and method that provides consumers with a search engine that anonymously sends search query results pertaining to products or services that the consumer is interested in buying. As shown in FIG. 1, the system 100 may comprise a first server 105a and a second server 106a with connectivity to mass storage units 111, 116, 110 and 115 for storage and retrieval of application data. Backup servers 105b and 106b and associated mass storage units MSU1 MSU2 may also be provided.

Exemplary applications include a SQL application, a windows server application, a search engine, web services, consumer profiles processor, merchant profiles processor, and a manager for anonymous nicknames of registered users of the system 100. Exemplary applications may preferably run in a distributed processing environment.

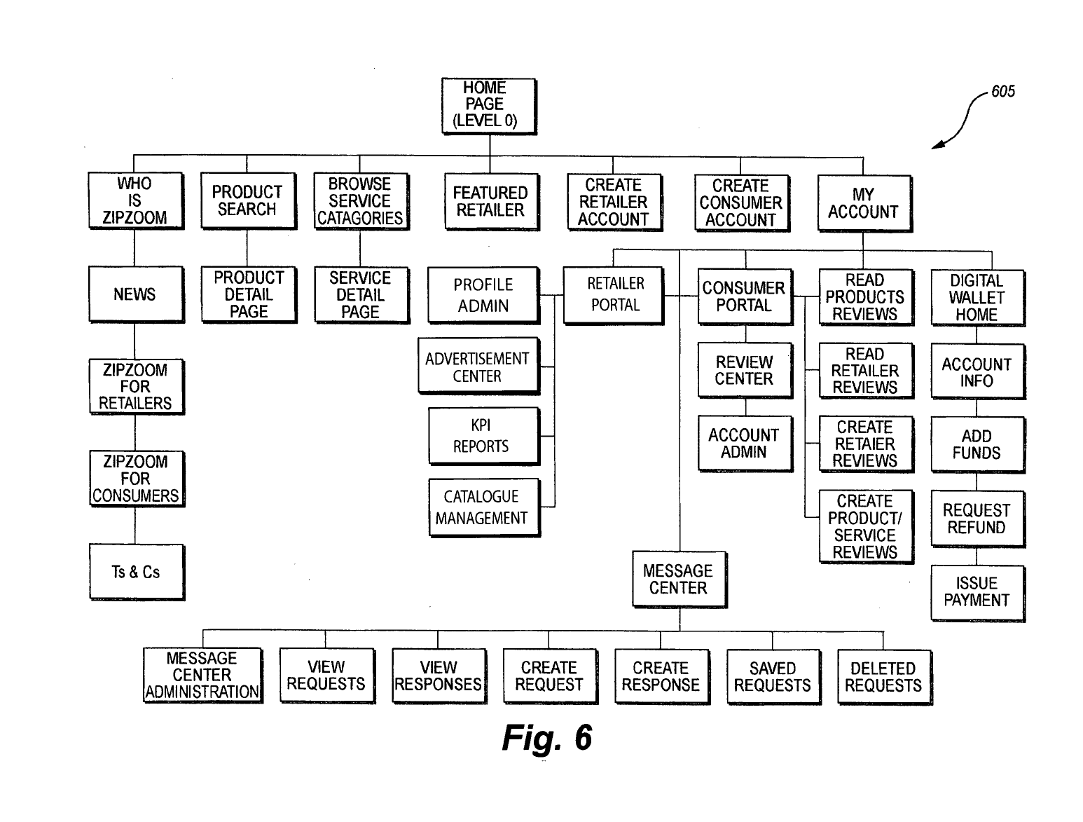

Exemplary mass storage units 110 and 115 may communicate with the servers 105 and 106 and store web pages, consumer profiles, merchant profiles, anonymous users' names, and a product/services database that holds product information and services information associated with the merchants who register with the system 100. The system 100 may accept a variety of product and service types, and may also accept services offered by a travel needs provider. The system 100 may provide a language translation feature and/or provide web pages in a plurality of languages. The system 100 utilizes application programming interfaces (API's) and/or user interfaces (UI's) to accept requests from merchants' inventory and financial programs such as, for example Excel®, Quickbooks®, or other programs requiring financial or inventory control conversion. Preferably, using the appropriate API's and UI's, for access to merchants' inventory control programs, spreadsheet programs, or the like, the system 100 can automatically accept a plurality of merchant products and product descriptions into the product database. The system 100 provides a website for consumers and merchants. A preferable organization of website pages exemplified by website navigation map 605 is shown in FIG. 6. A web page explaining terms and conditions (Ts & Cs) regarding website usage may be provided for consumers and merchants of system 100.

A general blog where people can ask questions and get responses from other customers may also be provided via applications running within the system 100. Social networks, groups, clubs and organizations related to products in the product database may be maintained within the system 100. The system 100 may also provide a product rating system and comment section that can be integrated into the product search results. Additional services such as maps for travel, flight information, etc. are also contemplated. The system 100 compels registered buyers/consumers to use a buyer/consumer nickname in order to retain anonymity throughout the system 100 while searching products, using chat, perusing or creating product reviews, comments and ratings, or the like. Consumers will use their nicknames when making a request or completing a transaction; i.e. purchase thereby remaining anonymous and spam free.

Additionally, a digital wallet application resides in system 100 to store and retrieve user account information that is used to assist in completing a sale of a merchant's item to the consumer. The digital wallet application provides a digital wallet to facilitate payments between consumers and retailers.

The digital wallet basically operates like a bank account with the difference that all tenants of the website bank at the same institution thereby facilitating the transfer of funds between accounts. The system 100 provides system users with the ability to treat their digital wallet account like an online bill payment service in which personal information, e.g., credit card information is not collected or used. Consumers and retailers will have a choice whether to use the payment system provided by the digital wallet application. Moreover, digital wallet application includes privacy and security features (e.g. a public key cryptographic encryption system) to encourage use of the system 100. As discussed infra, at no time is the name of the user divulged. Moreover, at no time is transactional information such as credit card numbers, S.S.N./S.I.N., or other personal financial information used, divulged or stored on the site. Additionally, data and other information may be separated thought several servers to protect valuable information. The digital wallet application is capable of generating a plurality of useful Key Performance Indicator (KPI) reports, such as items most sold, average purchase price, sales amount, and the like. A variety of currency types may be processed by the digital wallet application.

Preferably, the system 100 communicates with clients 120 and 130 via Internet 102. Computers 130 are exemplary web-enabled merchant devices. Computers 120 are exemplary web-enabled consumer devices. Users having an Internet-ready Web-enabled device, such as computers 120, a PDA, a laptop, a notebook, a cell phone, and the like, may log onto a website provided by server 105. It should be understood that merchants may also log onto the system 100, provided that the merchants have computing equipment, such as computers 130, a PDA, a laptop, a cell phone, or the like, and may create merchant profiles, upload/download product/services information, and the like. The system 100 may deposit Internet “cookies” in merchants' computers 130 and consumers' computers 120 in order to store settings created during sessions with the system 100.

The realization of the inventive site's conceptual new approach to the web is disposed on a tried and tested software and hardware stack. Current architecture plans for a Microsoft®.NET™ 2.0 application that has interoperable communication with a SQL server 2005 data structure. The application will be served by Microsoft® IIS (Internet Information Services) on Microsoft® windows server 2003. This software's architecture will reside within a truly high availability environment having dual load balancers pointing across dual web servers that draw from a clustered SQL environment. Site search and user authentication will be handled or augmented by dedicated devices. The entire stack will be housed in a Grade 1 data center providing true power, cooling and bandwidth redundancy. Physical security will be handled by 24 hour controlled hands and eyes access and a state of the art fire detection and suppression system, ITD (Information Technology Databases)/ITP (Information Technology Programs) will be managed through high availability devices dedicated to the whole stack.

The system will provide several methods for retailers to upload additional products or services not presently catalogued within the site's own database (catalogue). The site will utilize mainly the products and descriptions of manufacturers thereby insuring that each product is presented within the manufacturer's specifications. From the main site's catalogue, retailers will be able to associate products or service to their catalogue, though creating their own catalogue, this ensuring that all submitted request reach the appropriate retailers.

There are two servers 105a, 106a and two back-up servers 105b, 106b. Each server has large capacities for processing and storing. Applications for data storage, digital wallet, message centers and the like preferably run in a distributed processing environment.

A method of payment known as a “digital wallet” will be provided to facilitate secure transactions within the site. Users will be able to transfer funds from their physical bank accounts to the wallet. Once the transfer is approved and verified, the user will be able to pay for products or purchase services by using their wallet. At no time is the name of the user divulged. At no time is transactional information like; credit card numbers, S.S.N./S.I.N., or other personal financial information used, divulged or stored on the site. Additionally each user will be provided with additional authentication devices to validate and authenticate each transaction.

The system/site provides a “messaging” system known as a “message center”. The search engine provides the user with the means to search for certain products or services. Once the user finds the product or service they were searching for, they can “click” on it at which time a “request form” will appear. The “request form” will list the product or service located previously as well as a description and a picture. The user may then add personal comments and click the submit button to start the “response process”. Each retailer or service provider “associated” to the product or service in the “request message” will receive the “request” in their message center. At this time the merchant has the choice to respond or not.

Each retailer will have to register and obtain a “digital wallet” to pay for the fees associated to either, the request responses and/or other advertising such as advertising banners. Fees will be paid each time a response is sent or for advertising, and the like.

Consumers wishing to purchase products or services through the secure payment system provided by the inventive site will have to register and obtain a “digital wallet”. This digital wallet will allow consumers to “anonymously” make online purchases for products and services from retailers/merchants registered on our site. Additionally, it will allow consumers to also anonymously purchase product and services at the physical location of the retailers/merchants registered on the inventive site by using an anonymous “digital debit card” through retailers/merchants POS system. When using the anonymous “digital debit card”, consumers will also need to enter a 6 digit authentication number, which number is provided to them through a “token”. The 6 digit authentication number changes every 60 seconds and it is provided to the token via a server.

The system provides a message center for communication between the users (consumers and merchants). The data received by the message center can be forwarded to external centers known as “email”. Several types of email can be used for this purpose. It should be understood that email are an external message form, however the system uses a message center that is not associated to an address requiring @. The message center simply provides the recipient with a “To:” and “From:” making use of the “nicknames” chosen.

The system will provide a huge array of “reports” as per the following; top product or service searched for, top product or service requested and the like. The system does not keep track of purchases therefore it does not know top sales.

Search results are not forwarded or sent to the user's message center, however search results can be saved. Searches are done on the site, and responses to requests submitted are sent to the user's message center. It is possible to forward an alert email to the user, however the user will have to login to the site in order to read, reply or complete a transaction. This is due to the fact that the inventive system and procedures do not accept external communication from other devices but simply relay them. The same will apply to the retailer.

Utilizing the method of the present invention a consumer registers at the site and creates a profile using a nickname for their messaging system. The consumer, then via the search engine provided, searches for the product or service that they are wanting or in some cases use the search engine to narrow down or find the specific product or service they are looking for. Once the consumer finds the product or service a “request message” is provided, then completed by the consumer and then sent to all the retailers/merchants who have registered with the site and have selected the aforementioned product or service to be included in their own created catalogue. The retailers/merchants reserve the right to respond to the request. This is known as a “response” and if they respond they are charged a fee. The responses are then forwarded to the consumer's message box for review and or reply. The consumer will be able to sort these results in various manners. Consumers have the option to have an automatic email sent to them when responses are delivered to their message box.

The process follows a Sequential Order of Consumer Interaction, including the following steps. (1) A user is solicited to become a member of the site by being provided with a “free” trial period of the system. (2) The user provides a username, password and nickname. (3) The user can then search for products and services within the site and send a “request” to all the retailers/merchants who have registered with the site and have selected the product or service to be included in their own created catalogue. (4) A message box is provided for the user to receive responses from retailers or service providers. (5) The user, upon becoming a member, can obtain a “virtual account” to complete either online purchases or at the store level.

The process includes a corresponding Sequential Order of Retailer Interaction, including the following steps. (1) A merchant can register with the site by completing the appropriate forms and registering their products or services by association to a catalogue of the inventive system, though creating their own catalogue. (2) Once approved, the merchant must then register with the site's payment method (virtual account) to facilitate the payment of fees generated by the response system. (3) A registered merchant can receive and respond to requests submitted to their message center. (4) A registered merchant can use any payment method they wish to complete the sale or use the site's secure method (virtual account).

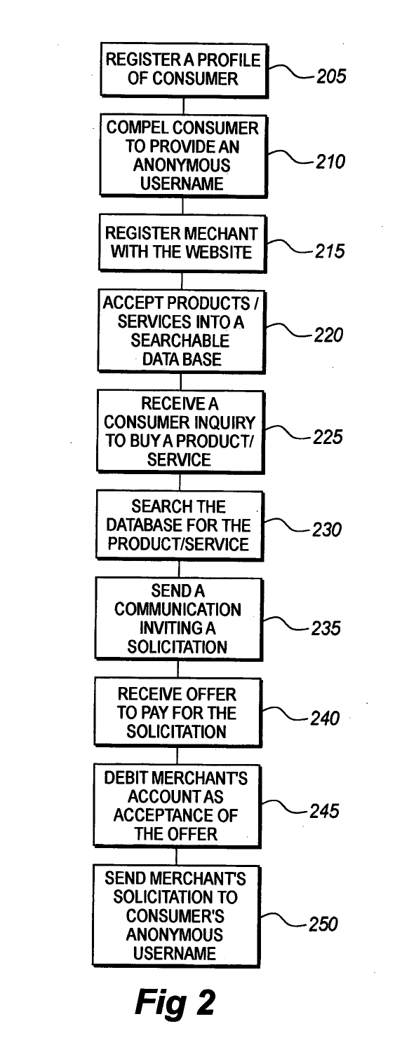

As shown in FIG. 2, method step 205 registers a consumer profile. At step 210, a user is compelled to provide an anonymous nickname for use in conducting searches, profile creation, and communicating with merchants who have registered with the website. At step 215, merchants who wish to be eligible for search returns via the search engine of system 100 must register with the system 100. At step 220, a plurality of products and services offered by the merchants is associated to the site's product catalogue. Should the product not exist then the retailer can upload the product or service. The site database may also include private party items for sale and accessible to other consumers on the website.

At step 225 the system receives consumer inquiries (in the form of search requests) regarding products or services specified by the consumer. At step 230 the system then searches the database for information regarding the products or services specified by the consumer.

Responsive to results from the database search, a communication to merchants who potentially may carry the product or offer the service is sent at step 235, the communication inviting a solicitation regarding the consumer's product or service inquiry. The system 100 associates consumers with unique anonymous nicknames that businesses can respond to. As shown at step 240, if the merchant chooses to respond with a solicitation, the system receives the offer from the merchant to pay for the solicitation, the solicitation being associated with the product or service specified by the consumer. The offer to pay for the solicitation may be in the form of merely initiating debit activity of a registered merchant who has setup a digital wallet, which, by definition, can be debited per response. The system 100 may also include software accessible to the merchant to generate automated replies having product/services information responsive to the consumer search queries. The system 100 may also accept uploads from merchants comprising files, pictures and multimedia commercials regarding the product/service solicitation.

At step 245, the system 100 generates a response fee by debiting the digital wallet of the merchant, the debiting being an acceptance of the solicitation offer from the merchant. The system 100 provides digital wallets for both merchants and consumers. Consumers utilize the message center to automatically prevent them from being bombarded with unwanted solicitations from a merchant.

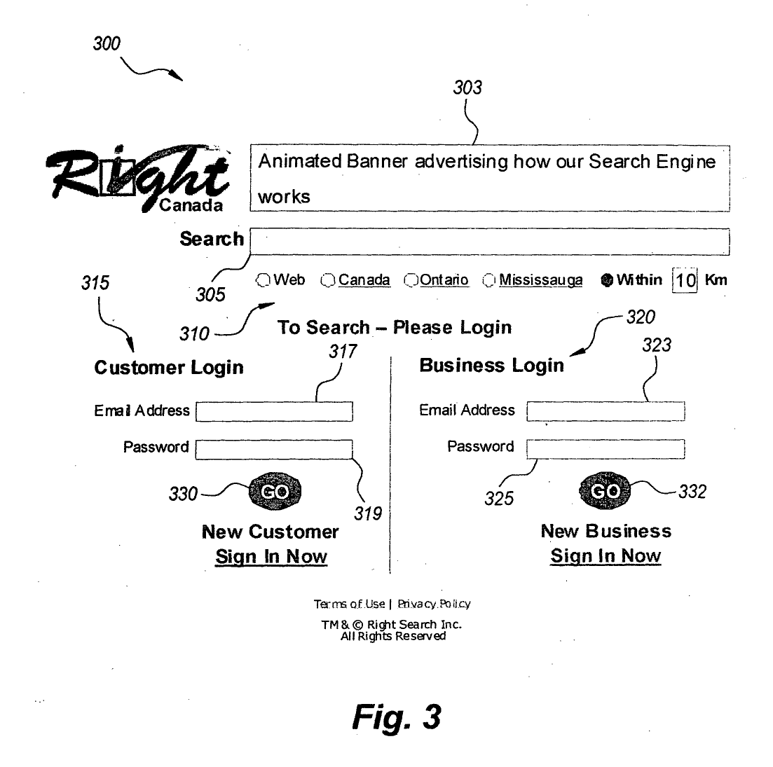

An exemplary web page 300 provided by web services of system 100 and accessible by consumer user systems 120 and merchant user systems 130 is illustrated in FIG. 3. The page may have animated banners 303 that advertise how the search engine of system 100 works. The web page will have a help button that will provide real live demo's to explain the functions of the website as well as the navigation and other helpful tips.

Geographic search criteria selection buttons 310 are provided to limit a search area. A plurality of additional search criteria selection buttons may be provided to enable a consumer to select a “best deal” that customizes a search according to the consumer's priorities, such as, e.g., merchant provided benefits, product availability, price, and the like. The sorting mechanism applies to responses within the message center. The user (when searching) is looking for something specific, generally this is one item not a series of items therefore there is no need to sort.

A customer login 315 and a business login 320 are provided. The customer login 315 has a customer username field 317, a password field 319, and a GO button 330. Once the fields 317 and 319 are filled in by the customer, the GO button 330 can be selected to complete the consumer login process.

Similarly, the business, i.e., merchant, login 320 has a username field 323 that may be populated, e.g. with a username that includes the merchants business name, a password field 325, and a GO button 332. Once the fields 323 and 325 are filled in by the customer, the GO button 332 can be selected to complete the merchant login process. Merchant registration is preferably, but not necessarily, without charge to the merchant. It should be understood that once the consumer logs into their account that they will be brought to a customized, localized page. This is possible due to the address being imputed by the consumer in the application process.

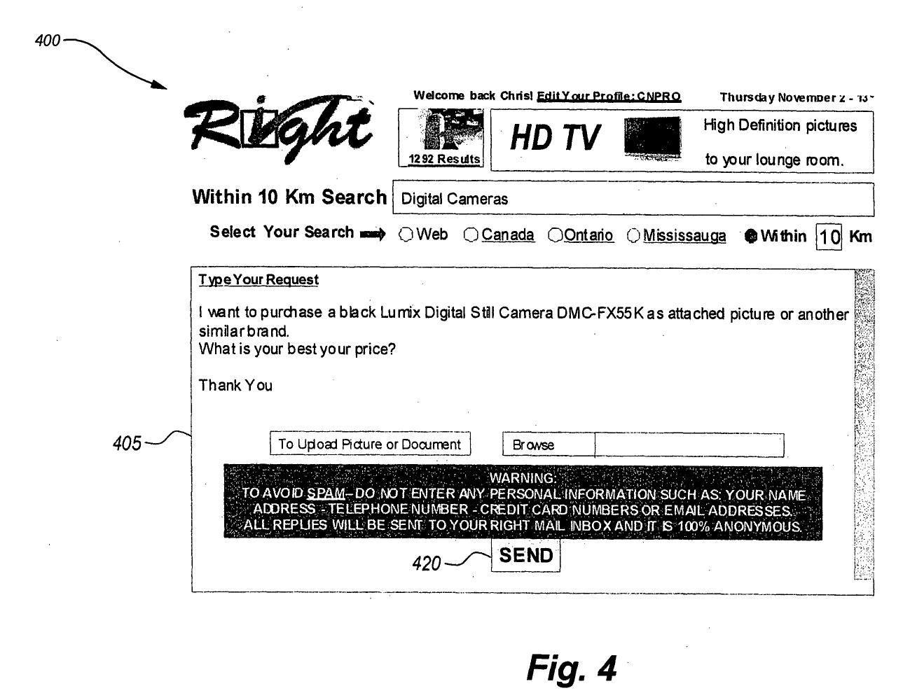

Exemplary search query page 400 is illustrated in FIG. 4. A search query box 405 is provided in which the consumer may enter text queries and/or supplemental information in the form of picture attachments, document attachments, or the like. Picture and document attachments are especially useful when the consumer is searching for a custom product or service, such as a custom-built cabinet. A send button 420 is provided for operator interaction with the system 100. A “request” is generated once a “search” is completed.

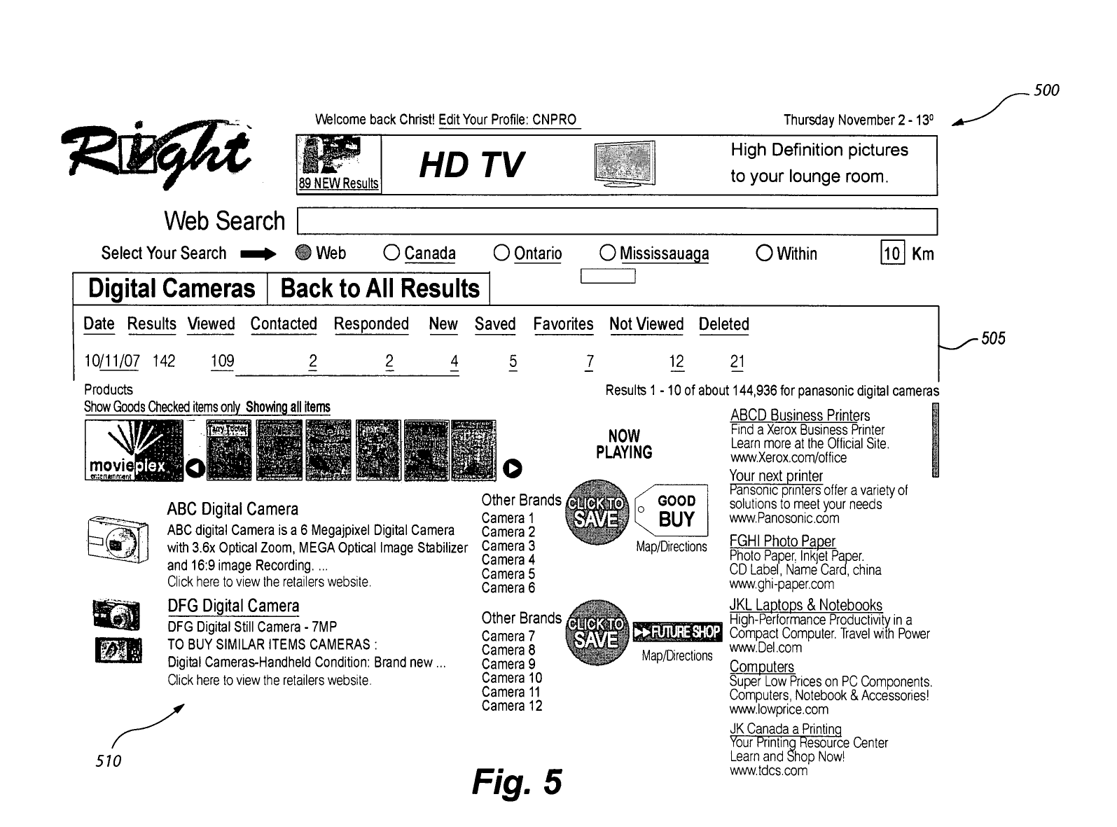

Exemplary search results page 500 is illustrated in FIG. 4. As shown in FIG. 5, search results 510 are provided. Organic search results of registered merchants are preferably conspicuously displayed in search results area 510, while “pay per click” search results may be disposed between search results area 510 and the borders of search results page 500. Search results are provided for a product “only”, not a merchant or retailer or service provider. The search tool is to help locate the product or service that the user is looking for, once that is accomplished a “request” for this product or service is provided.

Additionally, search statistics 505 are provided. Search statistics may include a search date, a number of results, a number of results viewed, a number of merchants contacted, a number of merchants who responded, a number of new searches, a number of saved searches, a number of searches marked as “favorites”, a number of searches not viewed, and a number of searches deleted.

The search results Search results are not forwarded or sent to the user's message center, however it can be saved. Searches are done on the site, responses to requests submitted are sent to the user's message center. It is possible to forward an alert email to the user however the user will have to login to the site in order to read, reply or complete a transaction. This is due to the fact that the inventive method and processes do not accept external communication from other devices but simply relay them. The same will apply to the retailer within the system 100. Moreover, businesses are blocked from sending other promotions at a later time because the system 100 automatically blocks the customer's anonymous username, guaranteeing that the business does not have direct or indirect access to the consumer's name, username, nickname, or any other contact information.

While businesses may view the consumer nickname, i.e., a user-specified name associated with the anonymous username, when responding, the system 100 prevents businesses and consumers from conducting searches on usernames, nicknames, anonymous username, and the like. Once a consumer decides to purchase a product or service displayed by the system 100 in his/her private results page, the consumer is given the option to print the results page, (or send it to a cell phone), and bring it to the merchant while making the purchase.

Alternatively, the consumer is given the option to respond online to the merchant solicitation by clicking on a special link to complete a purchase transaction with the merchant. In either option, merchants are provided with a quantifiable metric to gauge success of their advertising campaign via the system 100.

It is to be understood that the present invention is not limited to the embodiment described above, but encompasses any and all embodiments within the scope of the following claims.

1. A computer implemented reverse portal method, comprising the steps of:
registering a profile of at least one consumer in order to conduct a search using a product search website;
compelling the at least one consumer to provide an anonymous nickname for use in conducting searches and for communicating with at least one merchant associated with the website;
registering the at least one merchant with the website;
associating the merchant's products to the site's searchable product catalogue database;
receiving a request from the at least one registered consumer to inquire about at least one product or service specified by the consumer;
searching the database for the at least one product or service specified by the consumer;
sending a communication to the at least one merchant based on a result of the searching step, the communication inviting a solicitation regarding the consumer's product or service inquiry;
receiving an offer from the at least one registered merchant to pay for the solicitation to the at least one registered consumer, the solicitation being associated with the at least one specified product or service;
debiting an account of the at least one registered merchant, the debiting of the account being an acceptance of the offer from the merchant; and
communicating the merchant's solicitation to a private message center belonging to the at least one registered consumer.

2. The computer implemented reverse portal method according to claim 1, further comprising the step of providing the product search website in a plurality of languages.

3. The computer implemented reverse portal method according to claim 1, further comprising the step of automatically accepting a plurality of merchant products and product descriptions into the product catalogue database.

4. The computer implemented reverse portal method according to claim 1, wherein the database searching step is performed anonymously.

5. The computer implemented reverse portal method according to claim 1, further comprising a forwarding step in which internal communications are selectively forwarded to external e-mail centers.

6. The computer implemented reverse portal method according to claim 1, further comprising the step of integrating product ratings and comments into product search results.

7. The computer implemented reverse portal method according to claim 1, further comprising the step of providing consumers with a digital wallet payment system for payment of goods and services through the site, wherein consumers' personal financial information is not collected or used.

8. A reverse portal system, comprising:
a computer having a processor, an area of main memory connected to the processor, a storage medium connected to the processor, and a communications device connected to the processor adapted for connecting the computer to the Internet; and
computer software means stored on the storage medium and executable by the processor when loaded into main memory, the computer software means including:
means for publishing a product search website on the Internet;
means for registering a profile of at least one consumer in order to conduct a search using the product search website;
means for compelling the at least one consumer to provide an anonymous nickname for use in conducting searches and communicating with at least one merchant associated with the website;
means for registering the at least one merchant with the website;
means for associating the merchant's products to the site's searchable product catalogue;
means for receiving a request from the at least one registered consumer to inquire about at least one product or service specified by the consumer;
means for searching the database for the at least one product or service specified by the consumer;
means for sending a communication containing the consumer's anonymous nickname to the at least one merchant based on a result of the searching step;
means for receiving an offer from the at least one registered merchant to pay for a solicitation to the at least one registered consumer, the solicitation being associated with the at least one specified product or service;
means for debiting an account of the at least one registered merchant, the debiting of the account being an acceptance of the offer from the merchant; and
means for communicating the merchant's solicitation to a private message center belonging to the at least one registered consumer.

9. The reverse portal system according to claim 8, further comprising means for providing the product search website in a plurality of languages.

10. The reverse portal system according to claim 8, further comprising means for automatically accepting a plurality of merchant products and product descriptions into the product catalogue database.

11. The reverse portal system according to claim 8, further comprising means for searching the database anonymously.

12. The reverse portal system according to claim 8, further comprising means for selectively forwarding internal system communications to external e-mail centers.

13. The reverse portal system according to claim 8, further comprising means for integrating product ratings and comments into product search results.

14. The reverse portal system according to claim 8, further comprising means for payment of goods and services through the site, the payment means being accessible to the consumer, wherein the consumers' personal financial information is not collected or used.

15. A computer product comprising a medium readable by a computer, the medium having a plurality of instructions stored thereon implementing a reverse portal method, the instructions including:
a first set of instructions which, when loaded into main memory and executed by a processor, causes the processor to register a profile of at least one consumer in order to conduct a search using a product search website;
a second set of instructions which, when loaded into main memory and executed by a processor, causes the processor to compel the at least one consumer to provide an anonymous nickname for use in conducting searches and for communicating with at least one merchant associated with the website;
a third set of instructions which, when loaded into main memory and executed by a processor, causes the processor to register the at least one merchant with the website;
a fourth set of instructions which, when loaded into main memory and executed by a processor, causes the processor to associate the merchant's products to the site's searchable product catalogue;
a fifth set of instructions which, when loaded into main memory and executed by a processor, causes the processor to receive a request from the at least one registered consumer to inquire about at least one product or service specified by the consumer;
a sixth set of instructions which, when loaded into main memory and executed by a processor, causes the processor to search the database for the at least one product or service specified by the consumer;
a seventh set of instructions which, when loaded into main memory and executed by a processor, causes the processor to send a communication containing the consumer's anonymous nickname to the at least one merchant based on a result of the searching step;
an eighth set of instructions which, when loaded into main memory and executed by a processor, causes the processor to receive an offer from the at least one registered merchant to pay for a solicitation to the at least one registered consumer, the solicitation being associated with the at least one specified product or service;
a ninth set of instructions which, when loaded into main memory and executed by a processor, causes the processor to debit an account of the at least one registered merchant, the debiting of the account being an acceptance of the offer from the merchant; and
a tenth set of instructions which, when loaded into main memory and executed by a processor, causes the processor to communicate the merchant's solicitation to a private message center belonging to the at least one registered consumer.

16. The computer product according to claim 15, wherein said instructions further comprise an eleventh set of instructions which, when loaded into main memory and executed by a processor, causes the processor to provide the product search website in a plurality of languages.

17. The computer product according to claim 15, wherein said instructions further comprise a twelfth set of instructions which, when loaded into main memory and executed by a processor, causes the processor to automatically accept a plurality of merchant products and product descriptions into the product catalogue database.

18. The computer product according to claim 15, wherein said instructions further comprise a thirteenth set of instructions which, when loaded into main memory and executed by a processor, causes the processor to perform database searching anonymously.

19. The computer product according to claim 15, wherein said instructions further comprise a fourteenth set of instructions which, when loaded into main memory and executed by a processor, causes the processor to integrate product ratings and comments into product search results.

20. The computer product according to claim 15, wherein said instructions further comprise a fifteenth set of instructions which, when loaded into main memory and executed by a processor, causes the processor to provide consumers with a digital wallet payment system for payment of goods and services through the website, wherein consumers' personal financial information is not collected or used.
